(19) United States
(12) Patent Application Publication
(10) Pub. No.: US 2023/0153845 A1
(43) Pub. Date: May 18, 2023

(54) SYSTEM AND METHOD FOR GENERATING CUSTOM DATA MODELS FOR PREDICTIVE FORECASTING

(71) Applicant: Ready Signal, LLC, Ann Arbor, MI (US)

(72) Inventors: Jason Edward Harper, Ann Arbor, MI (US); Baylen Garrett Springer, Ann Arbor, MI (US); Jonathan Paul Prantner, Orchard Park, NY (US); Grant Daniel Miller, Granger, IN (US); Dakota Crisp, Pinkney, MI (US)

(21) Appl. No.: 17/936,998

(22) Filed: Sep. 30, 2022

Related U.S. Application Data
(60) Provisional application No. 63/251,774, filed on Oct. 4, 2021.

(51) Int. Cl. G06Q 30/0202; G06Q 30/0204

(52) U.S. Cl. CPC G06Q 30/0202; G06Q 30/0205

(57) ABSTRACT

A computer implemented method of generating a custom signal from a data library containing multiple datasets of variable values correlated with time and geography includes receiving a user defined target variable, a time parameter, and a geography parameter, determining the applicable datasets from the data library overlapping the user-defined time parameter or geography parameter, testing the control variables of the applicable datasets for statistical significance to the target variable, aggregating a custom signal of at least three control variables having the greatest statistical significance to the target variable. The method includes generating a forecasting model by determining an internal feature analysis, determining an optimal external feature analysis, and selecting an optimal feature set based on a statistical strength of the internal feature analysis and the optimal external feature analysis.

### CROSS-REFERENCE TO RELATED APPLICATIONS

This application claims the benefit of U.S. Provisional Application No. 63/251,774, entitled A System and Method For Determining Statistical Relationships, filed Oct. 4, 2021, the entirety of which is incorporated herein in its entirety.

### TECHNICAL FIELD

The present disclosure relates generally to a system and method for data analysis, and more specifically to a particular improvement in computer implemented data aggregation and analysis systems and methods. More specifically, the present disclosure departs from earlier approaches and improves on computer technology employed in generating customized data models, and identifying control variables for use in predictive forecasting models among aggregated data sets.

### BACKGROUND

Control data and external variables, often referred to as features, are critical for data scientists in all types of work, including but not limited to, forecasting models, contribution analysis, scoring, segmentation, classification, and impact analysis. For example, a marketer may attempt to understand the effectiveness of their advertising, however, without including control variables including economic, demographic, and weather factors, the analysis of the advertising effectiveness may result in a false positive or negative evaluation of the advertising efforts.

However, when using control data, there are a high number of sources for that control data and even more external variable features that can be utilized to improve the outcome and analysis. It can be difficult to identify all potentially relevant data sources to analyze, and it can be difficult to identify control variables against which to test relevant data sources for dependent correlations. Previous systems use individual sources of data that can be gathered and curated as needed, and/or also use data aggregation platforms which curate sources of data into a single platform. However, simply aggregating data does not provide accurate and usable outputs without transformation. Typically, the data, once aggregated, is then modeled by data scientists to determine relevant factors and final evaluation.

There are three main challenges to utilizing these data in modeling and analytics work. First, aggregating and manually testing data sets along with calculating the necessary data science transformations requires a slow and inefficient process. Second, for this data to be appropriately and usefully incorporated into modeling efforts, the data itself also needs to be analyzed to see if the data demonstrate signs of auto-correlation, non-normal distribution, and seasonality, and transform accordingly. Data scientists who perform the analysis and determine the model inherently introduce bias into the process depending on their hypotheses of what factors could be influencing the target variable. This bias could lead to making some false conclusions of the insight with the model, or simply having missed key factors that are driving the target variable which were not analyzed or tested, simply because it had not occurred to the analyst. In addition to bias, a data scientist may not have the necessarily skill set and education to identify, recognize or test the best data sets or control variables in order to develop a robust predictive model.

Therefore, improved systems of data analysis are needed. It would be preferable to provide systems and associated methods of identifying relevant data sets within an aggregated library of data sets and to identify control variables for use in predictive forecast modeling

### SUMMARY

A computer-implemented method generates a custom signal from a data library containing multiple datasets where each respective one of the datasets includes control variable values correlated with time, geography, or both. The method includes receiving, by a processor, a user input defining a target variable, a time parameter; and a geography parameter. The method include determining, by the processor, applicable datasets within the data library where there is a time or geography overlap between the respective one of the plurality of datasets and the time parameter and the geography parameter. The method includes selecting, by the processor, a first dataset of the plurality of applicable datasets for testing statistical relevance of the dataset to the target variable. The relevance testing includes applying, by the processor, a first data transform to each control variable of the first dataset based on the target variable. The relevance testing includes determining, by the processor, whether a statistically significant relationship exists between each control variable of the first dataset to the target variable. The relevance testing includes, for each control variable of the first dataset having a statistically significant relationship with the target variable, determining, by the processor, a strength of the statistically significant relationship between each control variable and the target variable. The method includes repeating the relevance testing for each applicable dataset. The method includes aggregating, by the processor, a custom signal of at least three control variables having the greatest strength of the statistically significant relationship between each control variable and the target variable.

A computer implemented method generates a forecasting model of a target variable within a desired prediction window from a dataset, wherein the dataset includes historical values of the target variable, a first control variable, a second control variable, a third control variable, a time parameter, and a geographical parameter. The method includes generating, by a processor, an internal feature analysis based on an influence of the target variable historical values on a target variable present value, including determining a p-value for the internal feature analysis. The method includes determining, with the processor, an optimal external feature analysis selection based on an influence of the first, second and third control variables on the target variable, including determining a p-value for each of the first, second, and third control variables of the optimal external feature analysis selection. The method includes selecting, by the processor, an optimal feature set from among the internal feature analysis and the optimal external feature analysis via iterative, step-wise regression based on a statistical strength of the internal feature analysis and optimal external feature analysis to the target variable. The method includes determining, by the processor, a control signal based on the optimal feature set and generating, by the processor, target variable prediction values within the prediction window based on the optimal feature set.

The method optionally includes determining, by the processor, a user-defined external feature analysis based on an influence of a user-defined feature on the target variable; determining, by the processor, a p-value for the user-defined external feature analysis. The step of selecting an optimal feature set may include applying an iterative, step-wise regression using the internal feature analysis, the optimal external feature analysis, and a user-defined external feature analysis.

The details of one or more implementations of the disclosure are set forth in the accompanying drawings and the description below. Other aspects, advantages, purposes, and features will be apparent upon review of the following specification in conjunction with the drawings.

### BRIEF DESCRIPTION OF THE DRAWINGS

FIG. 1 is schematic representation of a computer implemented system of the present disclosure detailing the functional modules of the system.

FIG. 2 is a schematic view of features and operations associated with a data profiling module of the system shown in FIG. 1.

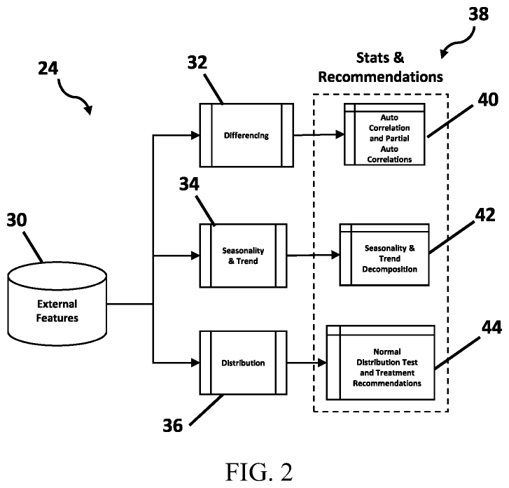

FIG. 3 is a schematic overview of an auto-discovery module of the system shown in FIG. 1.

FIG. 4 is a schematic view of the feature selection operation of the auto-discovery module of FIG. 3.

FIG. 5 is a schematic view of the feature testing operation of the auto-discovery module of FIG. 3.

FIG. 6 is a schematic view of an auto-forecasting module of the system shown in FIG. 1.

FIG. 7 is a schematic view of a fractional monetization module of the system shown in FIG. 1.

Like reference numerals indicate like parts throughout the drawings.

### DETAILED DESCRIPTION

The following terms may be used herein.

Internet refers to interconnected (public and/or private) networks that may be linked together by protocols (such as TCP/IP and HTTP) to form a globally accessible distributed network. While the term Internet refers to what is currently known (e.g., a publicly accessible distributed network), it also encompasses variations which may be made in the future, including new protocols or any changes or additions to existing protocols.

World Wide Web (“Web”, “WWW”) refers to (i) a distributed collection of user viewable or accessible documents (that may be referred to as Web documents or Web pages) or objects that may be accessible via a publicly accessible distributed network like the Internet, and/or (ii) the client and server software components which provide user access to documents and objects using communication protocols. A protocol that may be used to locate, deliver, or acquire Web document or objects through HTTP (or other protocols), and the Web pages may be encoded using HTML, tags, and/or scripts. The terms “Web” and “World Wide Web” encompass other languages and transport protocols including or in addition to HTML, and HTTP that may include security features, server-side, and/or client-side scripting.

Web Site refers to a system that serves content over a network using the protocols of the World Wide Web. A Web site may correspond to an Internet domain name, such as “bizfleets.com,” and may serve content associated or provided by an organization. The term may encompass (i) the hardware/software server components that serve objects and/or content over a network, and/or (ii) the “backend” hardware/software server components, including any standard, non-standard or specialized components, that may interact with the server interact with the server components that provide services for Web site users.

Application Programming Interface or Application Programming Endpoint or API is used to describe connections and other means of communication between disparate computer programs. These interfaces provide the standards for defining, managing and simplifying the programmatic communication.

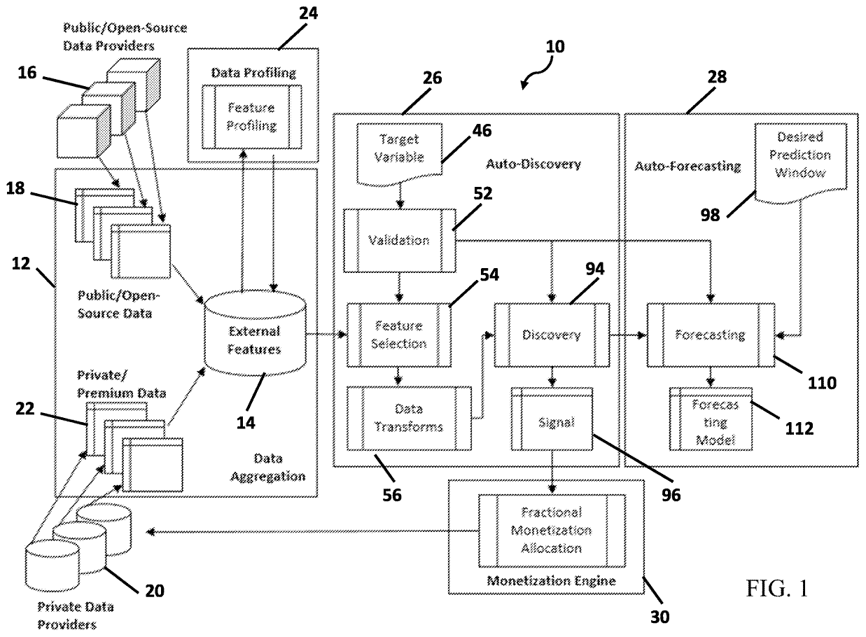

Referring now to the drawings and the illustrative embodiments depicted therein, FIG. 1 illustrates a schematic representation of the operational modules comprising a system 10 as disclosed herein. The system 10 comprises machine-executable software instructions stored in a memory of a computing device. The computing device includes a processor in electronic communication with the memory for executing the software instructions. The system 10 is described in terms of the logical flow for executing the sequential operations that may be programmed in software using conventional methodology in a range of different software languages. The computing device includes human-machine interfaces including input and output devices, such as keyboards, pointing devices, monitors, printers or the like. The computing device also include machine-machine interfaces, including network interface devices, such as modems, radio, WiFi, or the like.

The system 10 comprises machine executable instructions that when executed perform the operations as described in connection with the operational modules. A first module 12, is a data aggregation module that comprises a data library 14. The data library 14 aggregates data from multiple data sets or databases contributed to the library 14. The contribution of data may be from public or open-source data providers 16. This public or open-source data 18 may be governmental data, such as census data, or the like. The contribution of data may be from private entities 20, such as commercial technology companies, that gather or process data. The private or premium data 22 from private entities may be made available in the library 14 in exchange for financial compensation for the use of the premium data 22.

The system 10 includes a data profiling module 24. The data profiling module 24 analyzes each feature within a data set or database 18, 22 on-boarded to the library 14 and prepares the necessary analysis for utilizing the features in the other modules of the system 10. The features prepared through the data profiling module 24 are employed in the auto-discovery module 26, and the auto-forecasting module 28. The system 10 includes a factional monetization module 30 to allow data providers 20 to sell their data to consumers with compensation scaled among data providers based on the consumer usage of the data. Each of these modules 24, 26, 28, and 30 described in additional detail below.

Every data set 18, 22 added to the library 14 is processed by the data profiling module 24. Each data set 18, 22 comprises measured information associated with a time parameter representative of a creation of the measured information, and a geographical parameter representative of a source of the measured information. The measured information may be referred to as a control variable or, feature 30, and the data sets 18, 22 may each comprise multiple control variables or features depending on with the source of the data set 18, 22. The data profiling module 24 programmatically evaluates the multiple evaluations of the features and provides data science treatments to handle each scenario applicable to the subject data.

Each feature 30 contained within any data set 18, 22 added to the library 14 is analyzed by the data profiling module 24. The data profiling module 24 includes a differencing evaluation 32, including a time-based differencing, for determining whether each feature is characterized by autocorrelation and partial autocorrelation. The data profiling module 24 may provide a recommended differencing order to be applied to the data based on the result of the analysis. The data profiling module 24 may use a unit root test to determine a number of differences required for a time series to be made stationary. The data profiling module may use the Kwiatkowski-Phillips-Schmidt-Shin (KPSS) test to evaluate for the null hypothesis that the feature has a stationary root against a unit-root alternative. The data profiling module may deter the least number of differences required to pass the test at a given level. The data profiling module 24 includes a seasonality and trends evaluation 34. The seasonality and trends evaluation 34 will determine and recommend if seasonal differencing is required. The trend analysis may implement the KPSS test to evaluate the trend of the data and make recommendations accordingly. In other examples, the data profiling module 24 may use the Newey-West estimator in addition or in the alternative to the KPSS test. The data profiling module 24 also includes a distribution evaluation 36 that evaluates whether the data is stationary, and determines whether the data is normally distributed. The distribution evaluation may evaluate the Shapiro-Wilk test, kurtosis score, skewness score and Hartigan's dip test. The distribution evaluation 36 may also evaluate other data science treatments to provide a recommendation to address a data set that does not have a normal distribution, including Arcsin, Boxcox, Expoential, Log, Order Norm, Square Root, and Yeo Johnson.

The data profiling modules 24 outputs a stats and recommendations assessment 38. The stats and recommendations assessment 38 may be prepared on a feature-by-feature basis or a data set-by-data set basis representing multiple features. The stats and recommendations assessment 38 may contain information including identification of the source of the feature or data set, information identifying a name or title for the feature or data set, units, time parameter—such as the frequency over which the information was collected, as well as the time period over which the information was collected, geographic parameter—such as whether the information was collected on a national level, state-by-state, county-by-county, city-by-city, or other measure, and suggested treatment for the feature or data set. Suggested treatment may indicate the results of the differencing, seasonality and trends, and distribution evaluations 32, 34, 36. The stats and recommendations assessment 38 may contain information about autocorrelation and partial autocorrelations 40. The stats and recommendations assessment 38 may contain information about seasonality and trends decompositions 42. The stats and recommendations assessment 38 may contain information about the normal distribution test, and treatment recommendations 44. The stats and recommendations assessment 38 may contain combinations and sub-combinations of information about autocorrelation and partial autocorrelations 40, information about seasonality and trends decompositions 42, information about the normal distribution test, and treatment recommendations 44.

The time parameter and geographic parameter may assess the granularity of the information measured over time. For example, the time grain may refer to the interval between a first measured value of the data and a subsequent measure value. In one implementation, data may be measured on a daily time grain basis. In another implementation, data may be measured on a monthly time grain basis. Where the feature 30 or dataset 18, 22 is added to the library with a fine grain, the information may be rolled up to a coarser grain by the data profiling module 24. For example, daily measured values may be averaged to achieve weekly or monthly values. Information is not transformed by the data profiling module 24 from a coarse time grain to a finer time grain.

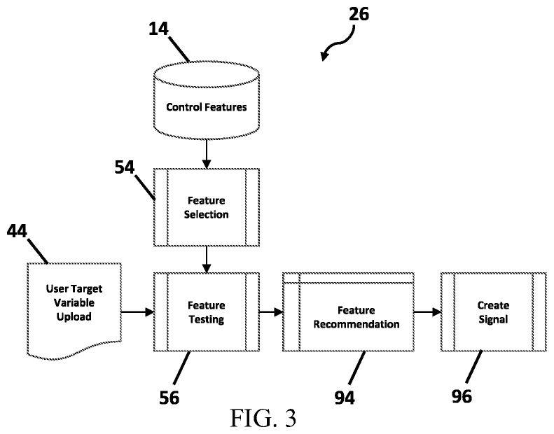

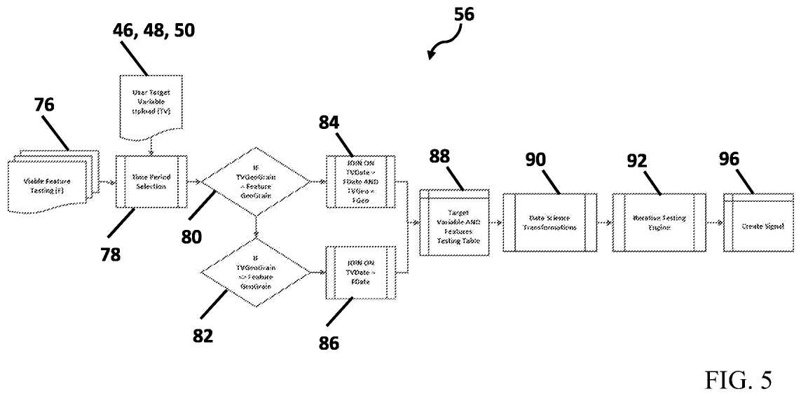

The system 10 includes the auto-discovery module 26 to curate and normalize disparate sources of data into a signal of relevant control variables identified by the system 10. For clarity, use of the term “signal” as used herein refers to compilations of data stored in a non-transient data storage medium, and does not refer to transitory electrical impulses or waves. Where it not possible for individuals or conventional data aggregations platforms to effectively or efficiently test all potentially relevant data, the system 10 transforms data from the data sets 18, 20, in view of the stats and recommendations assessment 38, to determine the influence of the data on a target of the data science research. Moreover, the system 10 separates the data processing from any potential sources of bias in developing a hypothesis on what factors could be influencing the research target. The auto-discovery module tests all possible data sets for statistical relationship to the research target, or target variable 46 as illustrated in FIGS. 3-5. The auto-discovery module 26 develops a signal including control variables identified and recommended by the system 10 to provide the user with a minimum of three or more control variables to be include for use in a user's predictive model.

Referring to FIGS. 3, 4, and 5, the auto-discovery module 26 is illustrated in additional detail. The auto-discovery module 26 uses the data library 14 containing the plurality of data set 18, 22 and a user-uploaded target variable 46. The data sets 18, 22 in the data library 14 may include the stats and recommendations assessments 38. The target variable 46 is uploaded by the user to the system 10 as a target of the research. The processor receives, via the user input, a definition of the target variable. The target variable 46 includes a time parameter 48 and a geography parameter 50 that may be used by the other modules in the system 10. Alternatively, the auto-discovery module 26 may prompt the user to select a time parameter 48 including a minimum or start date and a maximum or end date. The time parameter 48 may define data time series or time grain designating, for example, daily, weekly, monthly, quarterly, and annually recorded values, and including start and end values or ranges. The geographic parameter 50 may define the data geographical series or geo grain designating, for example, country, state, province, county, postal code, and may designate included or excluded values. Alternatively, the auto-discovery module 26 may prompt the user to select a geography parameter 48 including a grain size selection or range, among, for example, city, state, national, zip code or other geographic delimiter.

The system 10 may test the user's submission target variable 46 in a validation 52. The validation 52 may test the user's submission for valid time or geography data formats and identify missing time periods. The user may be provided with validation feedback to revise or confirm the user's uploaded target variable 46.

The system 10 executes a feature selection 54 by the auto-discovery module 26 to determine all available control data features from the data library 14 where there is time and geography overlap between the target variable time parameter 48 and the geography parameter 50. The control data features in the data library 14 with an overlap with the target variable time parameter 48 and the geography parameter 50 are designated for feature testing. The feature selection 54 also normalizes all control data to the time parameter of the target variable 46. For example, if the user uploads a monthly target variable, and there are daily control variables available for testing, the auto-discovery module 26 aggregates the daily data to the monthly level to align to the target variable defined time grain. Control variables are only aggregated to a coarser time grain (i.e., daily to monthly) and are not disaggregated to a finer time grain (i.e., monthly to daily). Similar logic is applied for the geography parameter 50, with data available, for example, by country, state or province, and postal code standards, and may also be available by city, country, or the like.

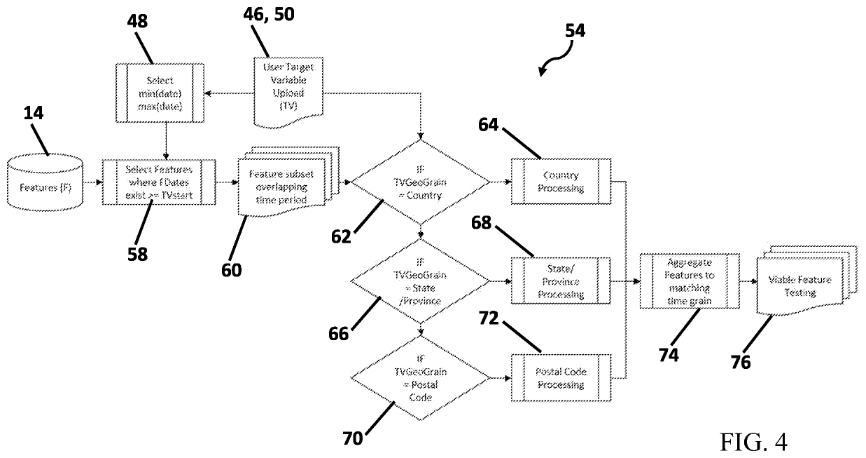

An example feature selection 54 implementation is illustrated in greater detail in FIG. 4. The user may upload a target variable 46 including a time parameter 48 and a geography parameter 50. The time parameter 48 may include a target range including a minimum time or start date and a maximum time or end date of the target variable. The feature selection 54 selects at 58 those features of the data library 14 where the target variable time period overlaps with the feature time period. The feature selection 54 generates a feature subset 60 of those features satisfying the time overlap with the target variable 46. The feature subset 60 is evaluated for geo grain overlap with the geography parameter 50. At 62, the feature selection 54 determines if the target variable geography parameter 50 is country, then all features with country level data in the feature subset 60 are selected at 64. If the target variable geography parameter 50 is country, then all features with state/province or postal code level data are aggregated to country totals at 64. If the same feature is available at country and state or province level or postal code level, only the country level feature is used. At 66, the feature selection 54 determines if the target variable geography parameter 50 is state or province level, features with state or province level data are selected at 68. Features with postal code level data may be aggregated to state or province totals. In some cases, geographic data may be disaggregated in features with country level data by using a population weighted distribution at 68 where appropriate. At 70, the feature selection 54 determines whether the geography parameter 50 is postal code, features with postal code level data are selected, and features with country or state/province level data may be disaggregated by a population weighted distribution at 72 where appropriate. Once the feature subset 60 has been normalized to the geography parameter 50, the feature subset 60 is aggregated to the time grain of the time parameter 48 of the target variable 46 at 74. The feature selection 54 then outputs a viable subset 76 of features selected for feature testing.

Based upon the viable subset of features 76 from the feature selection operation 54, the system 10 will loop through each feature, determine shared time periods between the user uploaded target variable 46 as defined by the time parameter 48 and the selected feature of the viable subset 76, matching feature data to the target variable data based on time parameter 48 and geography parameter 50 and check for statistical evidence of the feature impacting the target variable 46.

FIG. 56 illustrates the feature testing 56 in greater detail. Feature testing 56 uses the user submitted target variable 46, along with the time parameter 48 and geography parameter 50 to test the statistical relationship with the viable subset of features 76. In a first step at 78, the feature testing 56 calculates the overlapping time period for each feature in the subset 76 with the target variable time parameter 48. The calculation considers the minimum or start time of the target variable and the feature, and the maximum or end time of the target variable and feature. Features of the subset 76 that have an overlap are selected for further testing. Where there is no overlap, the feature is excluded from further testing.

The feature testing 56 then determines whether the geography parameter 50 of the target variable is equal to the geo grain of the feature at 80, or whether the geography parameter 50 is not equal to the feature geo grain at 82. Where the geography parameter 50 equals the geo grain of the feature, at 84, then the data is joined together based on both the time parameters and geography parameters. For example, if the target variable is monthly state level data and the feature is monthly state level data, then the data is joined together the feature testing 56 will match the data sets based on month and state. Where the geography parameter 50 does not equal the feature geo grain, at 86, then the data is joined together based on the time parameter, ignoring the geography as the key. For example, if the target variable is monthly state level data, and the feature is monthly national level data, then the data will only be matched by date, as there is no state value of the feature to match to. The feature testing 56 compiles a testing table at 88 of the target variable 46 and the features selected for further testing.

At operation 90, the feature testing 56 determines and applies the required data science transformations to each feature in the testing table 88. The data science transformations may include lead/lag analysis, difference analysis, ladder analysis, indexing, time series trend and time series seasonality. Other data science transformations may include anomaly detection, rolling averages, lag interactions, other interactions between lead and lag, differencing, seasonal differencing, natural log, exponential, inversion, square root, arcsine, cube root, squared, Box-Cox, order norm, Yeo-Johnson, standardized, seasonally adjusted, min-max scaling, and other like relationships. This list is not intended to be exhaustive and other transformations, both now known and future developed are contemplated for inclusion in the disclosed system. The system 10 determines which data science transformation to apply to which feature by determining if each feature has observations, which depends on the type of transformation. For example, the system 10 stores a defined set of rules based on the results of the stats and recommendations assessment 38 associated with the respective dataset or control variable within the dataset.

One example set of rules may be expressed in the sequence example presented at the end of the description and before the claims, which is present as an illustrative example and is not intended to be limiting.

At operation 92, the feature testing 56 executes an iterative set of hypothesis tests to each control variable feature to determine whether there is a statistical relationship and impact to the target variable 46 based on the feature. Said differently, the system selects a first dataset among those having an overlap in time or geography for testing the statistical relevance to the target variable, and repeats the testing among all applicable datasets. The selection of the first dataset is not intended to be limiting to a particular selection method, but instead describes the individual testing applied to all applicable control variable with respect to the target variable.

The feature testing 56 may employ tests that include determining a Pearson correlation coefficient, univariate regression, stepwise regression of applicable control variable features, and combinations thereof. Following the completion of the feature testing 56 performed iteratively at 92, the system 10 generates a feature recommendation 94 as a result of the feature testing 56 based on the correlation strength between the target variable and the feature. The features recommended at 92 are the top features for the signal 96 having the strongest statistical relationship to the target variable. The feature recommendation 94 returns at least three features of features in the data library 14 providing the descriptive statistics of the stats and recommendations assessment 38 along with strong, moderate or directional labeling for each feature based on the descriptive statistics and the results of the iterative testing 92 of feature testing 56. The feature recommendation 94 may return more than three features. For example, the feature recommendation 94 may return up to 20 control variable features. This is not intended to be limiting, and more or fewer control variable features may recommended.

Following the feature recommendation 94, the system 10 will create a custom signal 96 utilizing the recommended control variable features. The custom signal 96 includes a unique index capturing all the relevant signal features into a single feature specific to each target variable use case.

The system 10 includes an auto-forecasting module 28. The auto-forecasting module 28 is configured to identify salient features that can be used to predict future values of the target variable 46. The auto-forecasting module 28 executes a process using data sources, including (1) internally generated features from the user uploaded target variable 46, (2) external control features from the custom signal 96, and optionally, (3) external user-added features. Internal feature generation captures the influence of the target variable's 46 history on its own current values. This process determines the information held within the target variable 46 alone based on the user uploaded information. Internal feature categories may be computed from the target variable including moving averages, seasonal decomposition, lags, and anomalies. It should be noted that multiple features may be used for each category. For example, the lag feature category may include 1-month lag, 2-month lag, and the like.

The second source of features, known as external control features, are the feature subset within the custom signal 96. The external control features provide high level information that may influence the target variable in various ways. Multiple lags are generated for each feature. Null data is addressed to enable multiple comparisons, and a single lag is chosen for each feature. This process may use Akaike information criterion (AIC) comparison, but other alternatives are contemplated. Once lag optimization is complete, a process is used to reject highly correlated features. This process may use variance inflation factor, but other alternatives are contemplated. This process is also repeated for differenced data that makes the control features stationary.

The third, optional, source of features is any user-added features. For example, the user may provide feature data in addition to the target variable. The user-provided feature data may be automatically profiled by the data profiling module 24, as described above. The user-provided feature data may be specifically related to the target variable. This process is similar to the evaluation of the external control features from custom signal 96, representing another source of external data relative to the target variable 46.

With the two or three sources of feature data, the auto-forecasting module executes a process of external and internal optimal feature preparation. First, data sources are used in a step-wise fashion. Feature selection is first performed using the internal features combined with the external control features and then, optionally, with the internal features combined with the external control features further combined with external user added features. Second, multiple models based on selected subsets in various combinations of the internal features are put through the process. This step-wise execution tracks model performance across various information levels, and identifies core and tangential features for robusticity. This also assures better quality during model creation. In each case, feature selection is performed by step-wise linear regression where the feature with the highest p-value is iteratively removed until all remaining p-values are less than 0.05.

Once the final feature list is determined, dimensionality reduction is performed on all remaining external control features if greater than a specific number. If the reduced features set does not drastically reduce model performance, then this reduced control signal will be provided to the user as an optional alternative for modeling simplicity.

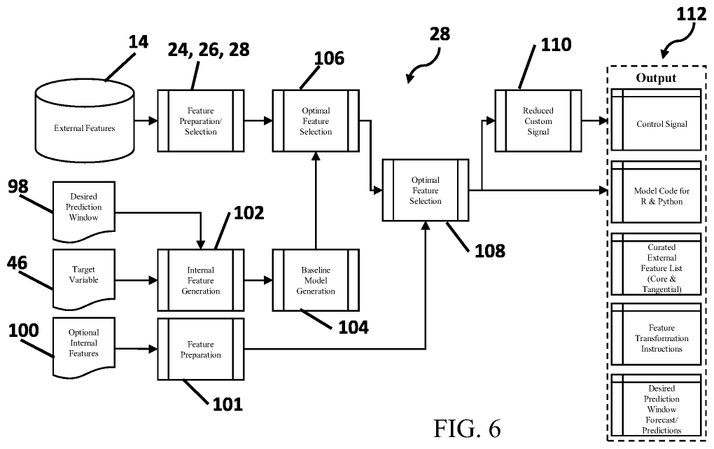

The auto-forecasting module 28 is illustrated in greater detail in FIG. 6. The auto-forecasting module utilizes the data library 14 which contains external features that have gone through a feature preparation process, such as performed by the data profiling module 24 as described above. The auto-discovery module 26 can provide a custom signal 96 containing a selection of optimal features for use in developing a predictive model for the target variable 46. The user provides a desired prediction window 98 defining a time range over which the desired values of the target variable 46 are desired. Optionally, the user can provide additional features 100. The user-provided additional features may go through a feature preparation process 101, such as performed by the data profiling module 24 as described above.

The auto-forecasting module 28 generates an internal feature analysis 102 to determine the influence of the target variable's 46 history on its own current values. The internal feature categories in the internal feature analysis 102 are computed from the target variable 26 alone and without any external information. Internal feature categories may include, but are not limited to, moving averages, seasonal decomposition, lags, anomalies, and others. Multiple features may be used for each category. For example, the lag feature category may include a 1-month lag, 2-month lag, and others. A baseline model 104 is generated from the internal feature analysis 102.

A first optimal feature selection process 106 is performed in a step-wise fashion. Feature selection is first performed using the internal features combined with the external features 106. The target variable may be analyzed in relation to the external feature variable in multiple categories, including moving averages, seasonal decompositions, lags, anomalies, and others. Multiple categories may be used for each external feature variable, individually, in combination, and in various sub-combinations. The optimal feature selection 106 may be performed by a step-wise linear regression where the feature analyses with the highest p-value is iteratively removed until all remaining features are (1) significant, or (2) removed, thereby cancelling the test. Alternatively, the feature analyses with the highest p-values are iteratively removed until all remaining features have p-values that are less than 0.05. The optimal feature selection 106 may include models with different information levels where feature selection is performed model by model, features are grouped by consistency, core and tangential features are identified and selecting between external features and the baseline model. Core features are features that have consistent significant relationships with the target variable 46. Tangential features are those having variable, or inconsistent, but non-nominal significant relationships with the target variable 46.

An optional, second optimal feature selection process 108 may be performed where user-provided additional features are provided. The second optimal feature selection 108 may be performed by a step-wise linear regression among the baseline model, the external features and the user-added optional features where the user-added optional feature with the highest p-value is iteratively removed until all remaining user-added optional features are (1) significant, or (2) removed, thereby cancelling the test. Alternatively, the user-added optional features with the highest p-values are iteratively removed until all remaining features have p-values that are less than 0.05. The optimal feature selection 108 may include models with different information levels where feature selection is performed model by model. Features may be grouped by consistency, and core and tangential features may be identified. Selection may be made between external features and the baseline model. The additional user-added optional features may be penalized more heavily for the internal feature generation as opposed to the external features. This ensures that external features are properly considered.

After the optimal feature selection 106 and optionally, the second optimal feature selection 108, are performed, the auto-forecasting module may perform dimensionality reduction on all remaining external control features if greater than a specific number. For example, the specific number may be selected by the user. The specific number may limit the model to three optimal features. The specific number may limit the model up to 10 optimal features. The specific number may be set by the system 10 to vary between three and 10 depending on the relative robusticity of the model with and without the feature. If the reduced features set does not drastically reduce model performance, then this reduced control signal 110 will be provided to the user as an optional alternative for modeling simplicity.

The auto-forecasting module 28 generates an output report 112 including a control signal representing the custom signal 96 or the reduced custom signal 110. The output report 112 may be delivered in a data science language, including python, R, or the like. The output report 112 may include information about the specific external feature set selected from the data library 14, including stats and recommendations assessment 38 and feature transformation instructions for each feature comprising the custom signal 96 or reduced custom signal 110. The output report 112 also includes the forecasted future or prediction values for the target variable 46 through the desired prediction window based on the control signal.

The system 10 includes a monetization engine 30 that executes a fractional monetization allocation to allow data provides to monetize their data through the system by submitting the data to the data library 14. The fractional monetization allocation scales the payment to the data provided based on the consumer usage of the data provided by the specific provider, aggregated over all usage in a given time interval. Private/premium data providers who have unique and valuable data for data scientists can aggregate their time series data and upload it to the system 10 to provide a way to monetize their data previously unavailable. The data provider can provide their own summary, description, marketing and source identification to induce users to utilize their data sets, for example, as user provided external features, in addition to selection via the auto-discovery module 26.

As custom signals are generated, the system 10 will track the usage of each feature and each private/premium data provider's features of all user-generated signals. The percent of total feature usage per each private/premium data provider will be determined by calculating the number of features used for the provider by the total number of features across all user-generated signals. The system 10 will allocate a defined percentage of monthly user revenue held for revenue sharing. The private/premium data provider portion of this revenue is determined by calculated percentage of features used that month for each provider.

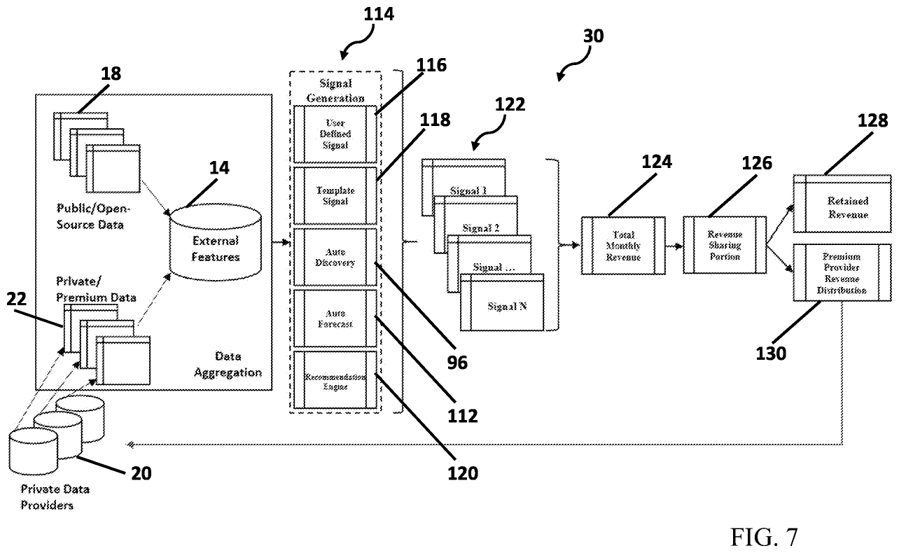

The monetization engine 30 is illustrated in FIG. 7. The monetization engine 30 evaluates the signal generation 114 performed by the system 10 to determine the usage of the different features contained in the data library 14 from data sets 18, 22, and for each private data set 22, determines an associated private/premium data provider 20. The signal generation 114 may include custom signals 96 generated by the auto-discovery module 26, or a reduced custom signal generated by the auto-forecasting module 28. The system 10 may support alternative methods of generating user-driven signals, such as where a user selected features from the data library 14 ala cart for exportation to use outside the system 10. The system 10 may package template signals 118, such as commonly utilized features, or collections of features suitable for data science research. The system 10 may provide alternative feature collections via a recommendation engine 120 to locate and extract certain features from the data library, for example, by completing a series of question-and-answer prompts provided by the system.

The monetization engine 30 tracks and monitors the utilization of each feature in any of a plurality of signals 122, including signal 1, signal 2, up to signal N, generated by the system 10 over a time period for which the fractional monetization allocation is performed. The monetization engine 30 also aggregates the total monthly revenue 124 for the system 10 over the same time period. The monetization may deduct certain predetermined amounts from the total monthly revenue 124, including overhead, administration, and other fixed costs, leaving a revenue sharing portion 126. A part of the revenue sharing portion 126 is retained by the system as retained revenue 128 which represents the portion of features in the plurality of signals derived from public or open source data or where the data set is submitted to the data library without a revenue sharing agreement. The remaining portion of revenue is the private/premium provider shareable revenue distribution 130. The private/premium provider revenue distribution is determined as a proportionate percentage of features attributable to a respective one of the private/premium data providers 20 relative to the total number of features comprising the plurality of signals 122 over the subject time period.

In one example implementation, the time period over which the fractional monetization allocation is performed, there may be 20 users resulting in a total revenue of $16,000 through the generation of 30 individual signals. Among the plurality of 30 signals, there are 300 total features. The data library received premium data sets from five premium providers included in the 300 total features utilized. Premium provider 1 contributed 60 of the 300 total features. Premium provider 2 contributed 30 of the 300 total features. Premium provider 3 contributed 10 of the 300 total features. Premium provider 4 contributed 5 of the 300 total features and Premium provider 5 contributed 1 of the 300 total features. The non-revenue sharing portion of the $16,000 total revenue was $11,200, or 70%, to cover the systems fixed costs. The remaining 30% of the $16,000 total revenue, or $4,800 is the revenue sharing portion and is divided with the system retaining a 194/300 share, or $3,104, and a 106/300 share, or $1,696, is divided among the premium providers. Premium provider 1 receives a 60/300 share of the $4,800 revenue sharing portion, or $960. Premium provider 2 receives $480, or a 30/300 share of the $4,800 revenue sharing portion. Premium provider 3 receives $160. Premium provider 4 receives $80. And, premium provider 5 receives $16.

It is contemplated that the described systems and methods herein will allow data providers the ability to monetize their data and the system will provide a platform for data providers large and small to sell their data to consumers. Also, the system may allow consumers to create their own features from sources they already have access to. For example, a data scientist may create industry specific features based on their own research that can be useful as a predictive model, examples include but are not limited to hotel room stays, lawn mower sales, cryptocurrency pricing, or other industry or application specific needs. As new data sources become available, the system can incorporate this data into the customized signal or model. The model and/or customized signal may be updated on a time basis or may be updated whenever new data is uploaded or found.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional implementations that also incorporate the recited features. It is also to be understood that the specific devices and processes illustrated in the attached drawings, and described in this specification are simply exemplary embodiments of the inventive concepts defined in the appended claims. Hence, specific dimensions and other physical characteristics relating to the embodiments disclosed herein are not to be considered as limiting, unless the claims expressly state otherwise.

Numbers, percentages, ratios, or other values stated herein are intended to include that value, and also other values that are “about,” “approximately,” or “substantially” the stated value, as would be appreciated by one of ordinary skill in the art encompassed by implementations of the present disclosure. A stated value should therefore be interpreted broadly enough to encompass values that are at least close enough to the stated value to perform a desired function or achieve a desired result. Also, the terms “approximately,” “about,” and “substantially” as used herein represent an amount close to the stated amount that still performs a desired function or achieves a desired result. For example, the terms “approximately,” “about,” and “substantially” may refer to an amount that is within less than 5% of, within less than 1% of, within less than 0.1% of, and within less than 0.01% of a stated amount.

Changes and modifications in the specifically described embodiments may be carried out without departing from the principles of the present invention, which is intended to be limited only by the scope of the appended claims as interpreted according to the principles of patent law. The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

The following is an illustrative example for expressing the rules as described above in connection with the disclosed system 10:

```
IF feature.short name = ##FEATURE 1##′
  echo ′This dataset is a zero / one indicator and not appropriate for transformation.′
ELSE IF feature.short name = ##FEATURE 2##′ OR feature.short name = ##FEATURE
3##′
  echo ′This dataset does not have enough history for a transformation analysis′
ELSE
  // Auto Correlation Analysis
  // Autocorrelation
  IF feature specs.name = ′Differences Suggested′ AND FIRST(feature_specs.statistic) >
0
    echo ′Data shows auto correlation indicating a need for differencing′
  ELSE IF feature specs.name = ′Differences Suggested′
    echo ′Data does not show strong auto correlation indicating no need for differencing′
  END IF
  //
  // Order Differencing
  IF EXIST feature specs.name = ′Differences Suggested′
    echo ″The ACF indicates ″ . feature specs.statistic . ″ order differencing is
appropriate.″
  END IF
  //
  // Differenced ACF
  IF feature_acfsj>acfs.name = ′ACF′ AND feature acfs pacfs.number = 2 AND
FIRST(feature_acfsj>acfs.diff_l) < 0
    echo ″Following first order differencing, no further differencing is required based on
the differenced ACF at lag one of″ . feature acfs pacfs.diff l
  ELSE IF featureacfspacfs.name = ′ACF′ AND featureacfspacfs.number = 2
    echo ″Further differencing is reccommended″;
  END IF
  //
  // Seasonal Differencing
  IF featurespecs.name = ′Seasonal Differences Suggested′ AND
FIRST(feature_specs. static) = 0
    echo ″Following differencing, no further differencing or seasonal differencing is
required″
  ELSE IF feature specs.name = ′Seasonal Differences Suggested′
    echo ″Seasonal differencing is recommended″
  END IF
  //
  // Trend Analysis
  IF feature specs.name = KPSS Trend′ AND FIRST(feature_specs.value) <= 0.5
    echo ″The Kwiatkowski-Phillips-Schmidt-Shin (KPSS) test, KPSS Trend = ″ .
FIRST(feature_specs->statistic) . ″ p-value = ″ . FIRST(feature specs.value). ″ indicates
that the data is not stationary.″
  ELSE IF feature specs.name = ′KPSS Trend′
    echo ″The Kwiatkowski-Phillips-Schmidt-Shin (KPSS) test, KPSS Trend = ″ .
FIRST(feature_specs->statistic) . ″ p-value = ″ . FIRST(feature specs.value). ″ indicates
that the data is stationary.″;
  END IF
  //
  // Distribution Analysis
  // Data Distributed
  IF feature specs.name = ′Shapiro′ AND FIRST(feature_specs.value) < 0.5
    echo ″The Shapiro-Wilk test returned W = ″ . FIRST(feature_specs.statistic). ″ with a
p-value =″ . FIRST(feature_specs.value) . ″ indicating the data does not follow a normal
distribution.″
  ELSE IF feature specs.name = ′Shapiro′
    echo ″The Shapiro-Wilk test returned W = ″ . FIRST(feature_specs.statistic). ″ with a
p-value =″ . FIRST(feature_specs.value) . ″ indicating the data follows a normal
distribution.″
  END IF
  //
  // Kurtosis Score
  IF feature specs.name = ′Kurtosis′ AND FIRST(feature_specs.statistic) > 1
    echo ″The kurtosis score of ″ . FIRST(feature_specs.statistic) . ″ indicates the
distribution has heavier tails and follows a leptokurtic distribution.″
  ELSE IF feature specs.name = ′Kurtosis′ AND FIRST(feature_specs.statistic) < -1
    echo ″The kurtosis score of ″ . FIRST(feature_specs.statistic) . ″ indicates the
distribution has lighter tails and follows a platykurtic distribution.″
  ELSE IF feature specs.name = ′Kurtosis′
    echo ″The kurtosis score of ″ . FIRST(feature_specs.statistic) . ″ indicates the
distribution is realtively normal and follows a mesokurtic distribution.″
  END IF
  //
  // Fairly Symmetrical
  IF feature specs.name = ′Skewness′ AND ABS(FIRST(feature_specs.statistic)) > 1
    echo ″A skewness score of″ . FIRST(feature_specs.statistic). ″ indicates the data are
substantially skewed.″
  ELSE IF feature specs.name = ′Skewness′ AND ABS(FIRST(feature_specs.statistic)) >
0.5
    echo ″A skewness score of″ . FIRST(feature_specs.statistic). ″ indicates the data are
moderately skewed.″
  ELSE IF feature specs.name = ′Skewness′
    echo ″A skewness score of″ . FIRST(feature_specs.statistic). ″ indicates the data are
fairly symmetrical.″
  END IF
  //
  // Dip Test
  IF feature specs.name = ′Dip Test′ AND FIRST(feature_specs.value) > 0.05
    echo ″Hartigan′s dip test score of″ . FIRST(feature_specs. statistic). ″ with a p-value
of″ . FIRST(feature_specs. value). ″ inidcates the data is unimodal″;
  ELSE IF feature specs.name = ′Dip Test′
echo ″Hartigan′s dip test score of″ . FIRST(feature_specs.statistic). ″ with a p-value
of″ . FIRST(feature_specs.value). ″ inidcates the data is multimodal″;
  END IF
  //
  // Statistics (Pearson P/ df, lower => more normal)
  Arcsin=> feature specs.name = arcsin
  Boxcox=> feature specs.name = boxcox
  Exponential => featurespecs.name = exponenetal
  Log=> feature specs.name = log
  Untransformed => feature specs.name = untransformed
  Order Norm => feature specs.name = order norm
  Square Root => feature specs.name = square root
  Yeo Johnson => feature specs.name = yeojohnson
//
END IF
//
```

1. A computer-implemented method of generating a custom signal from a data library, the data library comprising a plurality of datasets, each respective one of the plurality of datasets comprising control variable values correlated with time, geography, or both time and geography, the method comprising:
receiving, by a processor, a user input defining a target variable, a time parameter; and a geography parameter;
determining, by the processor, applicable datasets within the data library where there is a time or geography overlap between the respective one of the plurality of datasets and the time parameter and the geography parameter;
selecting, by the processor, a first dataset of the plurality of applicable datasets for testing relevance, wherein testing relevance comprises:
applying, by the processor, a first data transform to each control variable of the first dataset based on the target variable;
determining, by the processor, whether a statistically significant relationship exists between each control variable of the first dataset to the target variable; and
for each control variable of the first dataset having a statistically significant relationship with the target variable, determining, by the processor, a strength of the statistically significant relationship between each control variable and the target variable;
repeating, by the processor, the relevance testing for each applicable dataset; and
aggregating, by the processor, a custom signal of at least three control variables having a greatest strength of the statistically significant relationship between each control variable and the target variable.

2. A computer implemented method of generating a forecasting model of a target variable within a desired prediction window from a dataset, wherein the dataset comprises historical values of the target variable, a first control variable, a second control variable, a third control variable, a time parameter, and a geographical parameter, the method comprising:
generating, by a processor, an internal feature analysis based on an influence of the target variable historical values on a target variable present value, including determining a p-value for the internal feature analysis;
determining, with the processor, an optimal external feature analysis selection based on an influence of the first, second and third control variables on the target variable, including determining a p-value for each of the first, second, and third control variables of the optimal external feature analysis selection;
selecting, by the processor, an optimal feature set from among the internal feature analysis and the optimal external feature analysis via iterative, step-wise regression based on a statistical strength of the internal feature analysis and optimal external feature analysis to the target variable;
determining, by the processor, a control signal based on the optimal feature set; and
generating, by the processor, target variable prediction values within the prediction window based on the optimal feature set.

3. The method of claim 2, further comprising determining, by the processor, a user-defined external feature analysis based on an influence of a user-defined feature on the target variable;
determining, by the processor, a p-value for the user-defined external feature analysis; and wherein the step of selecting an optimal feature set further comprises applying an iterative, step-wise regression using the internal feature analysis, the optimal external feature analysis, and a user-defined external feature analysis.

4. The method of claim 2, wherein selecting an optimal feature set comprises removing, by the processor, a control feature with a highest non-significant p-value.

5. The method of claim 2, wherein the internal feature analysis comprises one of a moving average, a seasonal decomposition, a lag, and combinations thereof.

6. The method of claim 2, wherein the dataset comprises a fourth control variable; and
wherein determining the optimal external feature analysis comprises determining an influence of the fourth control variable on the target variable; and determining a p-value for the fourth control variable.

7. The method of claim 6, wherein the step of selecting the optimal feature set includes removing, by the processor, a control feature with a highest non-significant p-value.

8. The method of claim 7, further comprising determining, by the processor, a user-defined external feature analysis based on an influence of a user-defined feature on the target variable; and
determining, by the processor, a p-value for the user-defined external feature analysis; and wherein the step of selecting an optimal feature set further comprises applying an iterative, step-wise regression using the user-defined external feature analysis.

9. The method of claim 2, wherein determining the optimal external feature analysis selection comprises evaluating the influence of the first, second, and third control variables on the target variable in a category selected from among a moving average, a seasonal decomposition, a lag, anomalies, and combinations thereof.

10. The method of claim 9, comprising determining, by the processor, a core feature as a control variable having a consistent significant relationship with the target variable; and
determining, by the processor, a tangential feature as a control variable with inconsistent but non-nominal significant relationship with the target variable.

11. A system comprising:
a processor configured to execute machine executable instructions;
a memory in electronic communication with the processor, the memory configured to store machine executable instructions that when executed cause the processor to perform a set of operations comprising:
aggregating a custom signal of at least three control variables; and
generating a forecasting model of a target variable within a desired prediction window from the custom signal;
wherein aggregating the custom signal comprises:
receiving, by a processor, a user input defining a target variable, a time parameter;
and a geography parameter;
determining, by the processor, applicable datasets within the data library where there is a time or geography overlap between the respective one of the plurality of datasets and the time parameter and the geography parameter;
selecting, by the processor, a first dataset of the plurality of applicable datasets for testing relevance, wherein testing relevance comprises:
applying, by the processor, a first data transform to each control variable of the first dataset based on the target variable;
determining, by the processor, whether a statistically significant relationship exists between each control variable of the first dataset to the target variable; and
for each control variable of the first dataset having a statistically significant relationship with the target variable, determining, by the processor, a strength of the statistically significant relationship between each control variable and the target variable;
repeating, by the processor, the relevance testing for each applicable dataset; and
aggregating, by the processor, a custom signal of at least three control variables having a greatest strength of the statistically significant relationship between each control variable and the target variable; and
wherein generating the forecasting model comprises:
generating, by a processor, an internal feature analysis based on an influence of a target variable historical values on a target variable present value, including determining a p-value for the internal feature analysis;
determining, with the processor, an optimal external feature analysis selection based on an influence of the first, second and third control variables on the target variable, including determining a p-value for each of the first, second, and third control variables of the optimal external feature analysis selection;
selecting, by the processor, an optimal feature set from among the internal feature analysis and the optimal external feature analysis via iterative, step-wise regression based on a statistical strength of the internal feature analysis and optimal external feature analysis to the target variable;
determining, by the processor, a control signal based on the optimal feature set; and
generating, by the processor, target variable prediction values within the prediction window based on the optimal feature set..

12. The system of claim 11, wherein the memory stores machine executable instructions that when executed cause the processor to perform operations of generating a profiled dataset from external data and storing the profiled dataset in a data library.

13. The system of claim 12, wherein generating a profiled dataset comprises:
analyzing, by the processor, a set of source data for autocorrelation and partial auto-correlation;
analyzing, by the processor, the set of source data for seasonality and time-based trends;
determining, by the processor, whether the data is stationary;
determining, by the processor, whether the data is normally distributed; and
generating, by the processor, a data science treatment of the set of source data, the data science treatment comprising a recommended differencing order based on autocorrelation and partial autocorrelation; a recommended time-based differencing; and a distribution recommendation.

14. The system of claim 11, wherein the memory stores machine executable instructions that when executed cause the processor to perform an operation of determining a fractional monetization associated with the control signal.

15. The system of claim 14, wherein determining the fractional monetization comprises:
determining, by the processor, a source provider attributable for each control variable in the control signal, wherein each source provided may be a public source provider or a private source provider;
determining, by the processor, a shareable revenue value associated with the aggregation of the custom signal; and
allocating, by the processor, a respective portion of the shareable revenue value to each source provider determined to be a private source provider, the respective portion of shareable revenue being proportionate to a percentage of a number of control variables attributable to the provide source provided relative to a total number of control variables in the results dataset.

16. The system of claim 11, wherein the memory stores machine executable instructions that when executed cause the processor to perform operations of generating a profiled dataset from external data; storing the profiled dataset in a data library; and determining a fractional monetization associated with the control signal.

17. The system of claim 16, wherein generating a profiled dataset comprises:
analyzing, by the processor, a set of source data for autocorrelation and partial auto-correlation;
analyzing, by the processor, the set of source data for seasonality and time-based trends;
determining, by the processor, whether the data is stationary;
determining, by the processor, whether the data is normally distributed; and
generating, by the processor, a data science treatment of the set of source data, the data science treatment comprising a recommended differencing order based on autocorrelation and partial autocorrelation; a recommended time-based differencing; and a distribution recommendation.

18. The system of claim 16, wherein determining the fractional monetization comprises:
determining, by the processor, a source provider attributable for each control variable in the control signal, wherein each source provided may be a public source provider or a private source provider;
determining, by the processor, a shareable revenue value associated with the control signal; and
allocating, by the processor, a respective portion of the shareable revenue value to each source provider determined to be a private source provider, the respective portion of shareable revenue being proportionate to the percentage of the number of control variables attributable to the private source provider relative to a total number of control variables in the control signal.
